(19) United States
(12) Patent Application Publication
(10) Pub. No.: US 2026/0229195 A1
(43) Pub. Date: Aug. 6, 2026

(54) ZONE LIGHTING FOR BACKLIT DISPLAY

(71) Applicant: Ford Global Technologies, LLC, Dearborn, MI (US)

(72) Inventors: Biaohe Guo, Northville, MI (US); Mark Larry, Macomb, MI (US); Junghua Hsiao, Novi, MI (US)

(73) Assignee: Ford Global Technologies, LLC, Dearborn, MI (US)

(21) Appl. No.: 19/044,724

(22) Filed: Feb. 4, 2025

(51) Int. Cl. G09G 3/36; B60K 35/22; G09G 3/34

(52) U.S. Cl. CPC G09G 3/3607; G09G 3/3413; G09G 3/3426; B60K 35/22; B60K 2360/349; G09G 2320/0233; G09G 2320/0242; G09G 2320/062; G09G 2320/066; G09G 2354/00; G09G 2380/10

(57) ABSTRACT

A computer that includes a processor and a memory, the memory including instructions executable by the processor to determine intensity values of emitted light for red, green, and blue (RGB) sub-pixels of an LCD device based on data displayed on the LCD device. A first percentage of RGB sub-pixels can be determined that have intensity values that exceed a sub-pixel threshold for a first LCD zone of the LCD device. A second percentage of a full intensity value of emitted light for the RGB sub-pixels in the first LCD zone can be determined based on the first percentage. Intensity values of the LEDs in a first LED zone can be set to the second percentage of the full intensity value.

### BACKGROUND

Systems that move, can be carried, and/or that have mobile components, including vehicles, robots, drones, cell phones etc., can be operated by acquiring and processing sensor data, including data regarding system status and data regarding an environment around the system. Computing devices included in a vehicle can format and output the data to display devices for vehicle occupants to view and interact with via touch screen technology included in the display device.

### BRIEF DESCRIPTION OF THE DRAWINGS

FIG. 1 is a block diagram of an example vehicle system.

FIG. 2 is a diagram of an example vehicle display.

FIG. 3 is a diagram of an example liquid crystal display (LCD) front panel.

FIG. 4 is a diagram of an example liquid crystal display (LCD) device with light emitting diode (LED) backlight.

FIG. 5 is a diagram of an LED backlight.

FIG. 6 is a diagram of an LCD zone.

FIG. 7 is a flowchart diagram of an example process to control an LED backlight.

### DETAILED DESCRIPTION

Vehicles will be used herein as a non-limiting example of devices that can include display devices. Liquid crystal display (LCD) devices are examples of display devices that can be included in vehicles, where they may used to display data generated by or about the vehicle and components thereof. A computing device included in a vehicle can acquire data from vehicle sensors, from memory included in the computing device, and/or from network interfaces that can acquire data from sources such server computers and the Internet. A computing device included in the vehicle can acquire and process data and format it for display on an LCD device via a display controller. Data displayed on an LCD device includes text, depictions of gauges and instruments, depictions of controls such as buttons and image data such as maps and images that depict the environment around a vehicle.

An LCD device can display a wide variety of data including, but not limited to, vehicle status data such as vehicle speed, energy usage, and vehicle service notices, navigation data such as traffic and maps, climate control data such as temperature and air movement, infotainment data such as radio or satellite stations, and communications data such as cellular telephone data, cable TV, movies, video games, and the Internet via web browsers. Entertainment and communications data together can be referred to as infotainment data.

Data displayed on an LCD display device can be used to control vehicle components. For example, LCD devices can acquire user input to control vehicle components. For example, data regarding vehicle environmental controls or vehicle communication controls can be displayed on an LCD device along with icons that indicate vehicle component controls. Touching the icons can control the vehicle component, for example changing the temperature or changing the volume of audio output. Further, vehicle data regarding vehicle status such as speed or heading can be displayed on an LCD display device.

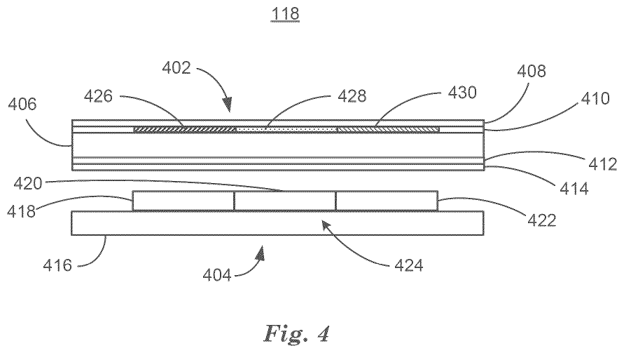

LED backlights can include an array of LEDs on a substrate behind the LCD front panel. Direct-lit (also known as full-array local dimming or FALD) can save power over other types of backlights such as edge lit backlights by permitting the backlight to be modulated to match the light to be emitted from the LCD front panel. LCD devices with LED backlights can employ red, green, and blue (RGB) LEDs integrated into a single LED package to form a white LED. In other examples a blue LED with a yellow phosphor coating or quantum dot coating can be combined to form a white LED. The LCD front panel can include a color filter as described below in relation to FIG. 4, below includes red, green, and blue (RGB) sub-pixel filters where each color is energized by diffused white LEDs. The RGB sub-pixel filters are combined into a single color pixel by light emitted by the LCD front panel.

Full dynamic range is the difference between the darkest possible portion of an LCD device and the brightest possible portion of the LCD display, which can be measured in lux, or luminous flux per unit area. Lux is a measurement of lumens per square meter where a lumen is a measure of light intensity weighted by a human eye light sensitivity function. Related to dynamic range is contrast ratio which is the ratio of the brightness of adjacent regions of a display expressed as a percentage of the full dynamic range. A dim region of a display can be defined as a region having an average brightness level which is less than about 33% of the full dynamic range. An intermediate region of a display can be defined as a region having an average brightness level between about 33% and 66% of the full dynamic range. A bright region of a display can be defined as a region having an average brightness level greater than about 66% of the full dynamic range.

Fine details are displayed by pixels that contrast with adjacent portions on an LCD device to allow them to be perceived visually by a user. Fine details are typically one or two pixels (e.g., 1% or 2% of the LCD screen size) wide, that is, provide depictions of objects typically in one dimension. Examples of fine details include roads on a map, text, or lines that indicate the boundary of a control such as a button or dial. Fine detail on an LCD device can be difficult for a user to perceive visually when the fine detail occurs in a dim region of a display. Fine detail can also be difficult for a user to perceive visually when the ambient light is bright, such a direct sunlight coming into a vehicle interior.

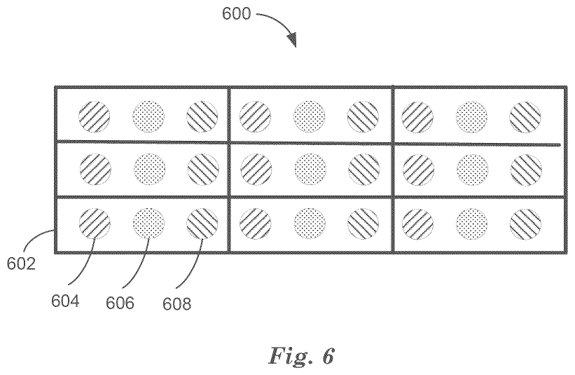

Techniques for zone lighting described herein can enhance fine detail data displayed on LCD devices by a computing device determining portions of data displayed on an LCD device that include fine detail in an otherwise dim portion of the LCD device. The LEDs in the determined portions of the LCD device can be boosted to enhance the appearance of fine detail in dim portions of data displayed on an LCD device by the computing device. Ambient light levels can be determined by a sensor providing data to the computing device and LEDS in dim portions of data displayed on an LCD device can be boosted based on the determined ambient light levels by the computing device. Boosting means to increase brightness of an LED pixel multiplicatively as will be described below in relation to FIG. 6.

For example, an LCD device can display map data to be used for vehicle navigation by a user. Maps can include portions with wide variance in brightness based on the data being displayed. Dim portions of the displayed map can include fine detail, for example roads, that would be good to be highly visible to the user. Techniques for zone lighting described herein can enhance fine detail in dim portions of a display to enhance the usefulness of displayed data on a backlit LCD device in portions that include fine detail and leave other portions of the LCD device that do not include fine detail dim. Techniques described herein for zone lighting of LCD devices can enhance the appearance and usability of LCD devices by providing enhanced visibility for portions of an LCD display that includes fine detail in an image, a menu, a virtual button, a virtual control, and/or a map feature, etc., while saving power by leaving other portions of the LCD device that do not include fine detail dim.

Disclosed herein is a method, including determining intensity values of emitted light for red, green, and blue (RGB) sub-pixels of an LCD device based on data displayed on the LCD device and determining a first percentage of RGB sub-pixels that have intensity values that exceed a sub-pixel threshold for a first LCD zone of the LCD device. A second percentage of a full intensity value of emitted light for the RGB sub-pixels in the first LCD zone can be determined based on the first percentage and intensity values of LEDs in a first LED zone can be set to the second percentage of the full intensity value. The intensity values of LEDs in second LED zones adjacent to the first LED zone can be set to a third percentage of the second percentage of full intensity value. The second percentage of the full intensity value can be changed to a third percentage of the full intensity value based on ambient light acquired by an ambient light sensor. The ambient light sensor can include a photodiode or a video camera.

The first percentage can include multiple first percentages based on multiple percentage thresholds. The second percentage can include multiple second percentages of full luminance based on the multiple first percentages. The second percentage of full illumination can be determined based on analyzing the data to be displayed on the LCD device. Analyzing the data to be displayed on the LCD device can include determining zones that benefit from increasing the intensity values of the LEDs. The LCD device can be included in a vehicle. Determining the intensity can be based on providing visibility for an image, a menu, a virtual button, a virtual control, and/or a map feature. The intensity values of the RGB sub-pixels can be determined based on values included in pixels in image data included in memory of a computing device. The intensity values of the first LEDs can be set by transmitting the image data from the memory of the computing device to the LCD device via a display controller. Zones that benefit from increasing the intensity values of the LEDs can include fine detail. Fine detail can include features of two pixels width.

Further disclosed is a computer readable medium, storing program instructions for executing some or all of the above method steps. Further disclosed is a computer programmed for executing some or all of the above method steps, including a computer apparatus, programmed to determine intensity values of emitted light for red, green, and blue (RGB) sub-pixels of an LCD device based on data displayed on the LCD device and determine a first percentage of RGB sub-pixels that have intensity values that exceed a sub-pixel threshold for a first LCD zone of the LCD device. A second percentage of a full intensity value of emitted light for the RGB sub-pixels in the first LCD zone can be determined based on the first percentage and intensity values of LEDs in a first LED zone can be set to the second percentage of the full intensity value. The intensity values of LEDs in second LED zones adjacent to the first LED zone can be set to a third percentage of the second percentage of full intensity value. The second percentage of the full intensity value can be changed to a third percentage of the full intensity value based on ambient light acquired by an ambient light sensor. The ambient light sensor can include a photodiode or a video camera.

The instructions can include further instructions where the first percentage can include multiple first percentages based on multiple percentage thresholds. The second percentage can include multiple second percentages of full luminance based on the multiple first percentages. The second percentage of full illumination can be determined based on analyzing the data to be displayed on the LCD device. Analyzing the data to be displayed on the LCD device can include determining zones that benefit from increasing the intensity values of the LEDs. The LCD device can be included in a vehicle. Determining the intensity can be based on providing visibility for an image, a menu, a virtual button, a virtual control, and/or a map feature. The intensity values of the RGB sub-pixels can be determined based on values included in pixels in image data included in memory of a computing device. The intensity values of the first LEDs can be set by transmitting the image data from the memory of the computing device to the LCD device via a display controller. Zones that benefit from increasing the intensity values of the LEDs can include fine detail. Fine detail can include features of two pixels width.

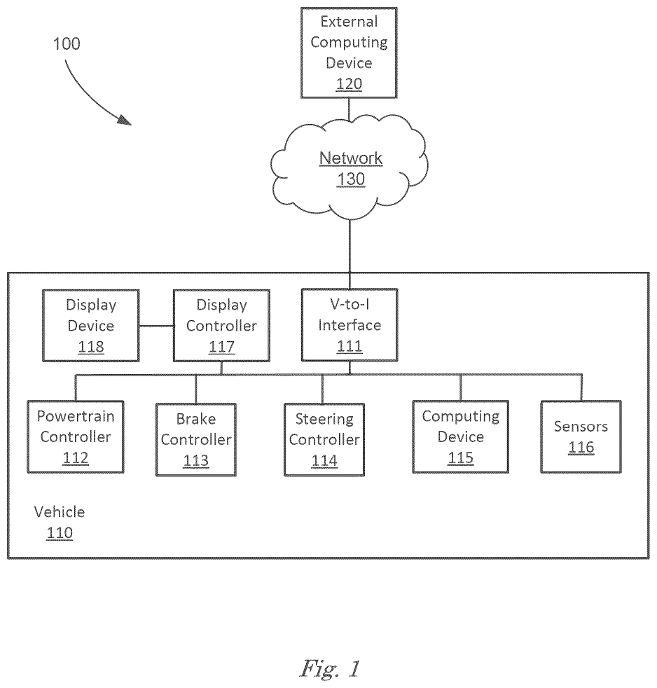

FIG. 1 is a diagram of vehicle system 100. Vehicle system 100 includes a vehicle 110. The vehicle 110 is generally a land-based vehicle 110 capable of autonomous and semi-autonomous operation and having three or more wheels, (i.e., a passenger car, light truck, etc.). Vehicle 110 includes one or more sensors 116, the V2I interface 111, a computing device 115, one or more controllers 112, 113, 114, 117 and a display device 118. One or more vehicle computing devices 115 can receive data regarding the operation of the vehicle 110 from sensors 116.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and exterior lights, etc., as well as to determine whether and when the computing device 115, as opposed to a human operator, is to control such operations. The computing device 115 can also control the temporal alignment of lighting to sensor acquisition to account for the color effects of vehicle lights or external lights.

The computing device 115 may include or be communicatively coupled to, (i.e., via a vehicle communications bus as described further below), more than one computing devices, (i.e., controllers or the like included in the vehicle 110 for monitoring and controlling various vehicle components), (i.e., a propulsion controller 112, a brake controller 113, a steering controller 114, display controller 117 etc.). The computing device 115 is generally arranged for communications on a vehicle communication network, (i.e., including a bus in the vehicle 110 such as a controller area network (CAN) or the like); the vehicle 110 network can additionally or alternatively include wired or wireless communication mechanisms such as are known, (i.e., Ethernet or other communication protocols).

Via the vehicle network, the computing device 115 may transmit messages to various devices in vehicle 110 and receive messages from the various devices, (i.e., controllers, actuators, sensors, etc., including sensors 116). Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network. In addition, the computing device 115 may be configured for communicating through a vehicle-to-infrastructure (V2I) interface 111 with an external computing device 120, (i.e., a cloud server), via a network 130, which, as described below, includes hardware, firmware, and software that permits computing device 115 to communicate with an external computing device 120, which can include the Internet via a network 130 such as wireless Internet (e.g., WI-FI®) or cellular networks. V2X interface 111 may accordingly include processors, memory, transceivers, etc., configured to utilize various wired and wireless networking technologies, (i.e., cellular, BLUETOOTH®, Bluetooth Low Energy (BLE), Ultra-Wideband (UWB), Peer-to-Peer communication, UWB based Radar, IEEE 802.11, and other wired and wireless packet networks or technologies). The computing device 115 also includes nonvolatile memory such as is known.

As already mentioned, generally included in instructions stored in the memory and executable by the processor of the computing device 115 is programming for operating one or more vehicle 110 components, (i.e., braking, steering, propulsion, etc.), without intervention of a human operator. Using data received in the computing device 115, (i.e., the sensor data from the sensors 116, an external computing device 120, etc.), the computing device 115 may make various determinations and control various vehicle 110 components and operations. For example, the computing device 115 may include programming to regulate or control vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and control a specific vehicle subsystem. Examples include a propulsion controller 112, a brake controller 113, a steering controller 114 and a display controller 117. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from another ECU included in vehicle 110, (e.g., the computing device 115, to operate the brakes of the vehicle 110).

The one or more controllers 112, 113, 114, 117 for the vehicle 110 may include known electronic control units (ECUs) or the like including, as non-limiting examples, one or more propulsion controllers 112, one or more brake controllers 113, one or more steering controllers 114 and one or more display controllers. Each of the controllers 112, 113, 114, 117 may include respective processors and memories and one or more actuators. The controllers 112, 113, 114, 117 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices such as are known to provide data via the vehicle communications bus. Sensors 116 may collect data related to the vehicle 110 and the environment in which the vehicle 110 is operating. By way of example, and not limitation, sensors 116 may include, (i.e., altimeters, cameras, LIDAR, radar, ultrasonic sensors, infrared sensors, pressure sensors, accelerometers, gyroscopes, temperature sensors, hall sensors, optical sensors, voltage sensors, current sensors, mechanical sensors such as switches, etc.). The sensors 116 may be used to sense the environment in which the vehicle 110 is operating, (i.e., sensors 116 can detect phenomena such as weather conditions (precipitation, external ambient temperature, etc.)), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114, 117 in the vehicle 110, connectivity between components, and accurate and timely performance of components of the vehicle 110.

Display device 118 displays two-dimensional visual data to occupants of a vehicle. Display device 118 can display visual data in monochrome and/or color and the visual data can be updated at a frame rate, which can be 60 frames per second, for example. Displayed visual data can be a static image, where the majority of the two-dimensional area does not change from frame to frame, or a dynamic image, where the majority of the two-dimensional area changes from frame to frame. Visual data to be displayed on display device 118 can be generated by display controller 117. Display controller 117 is a computing device such as an ECU or the like that can receive data to be displayed on display device 118 in a visual format from computing device 115, other vehicle ECUs, or from an external computing device 120 via network 130.

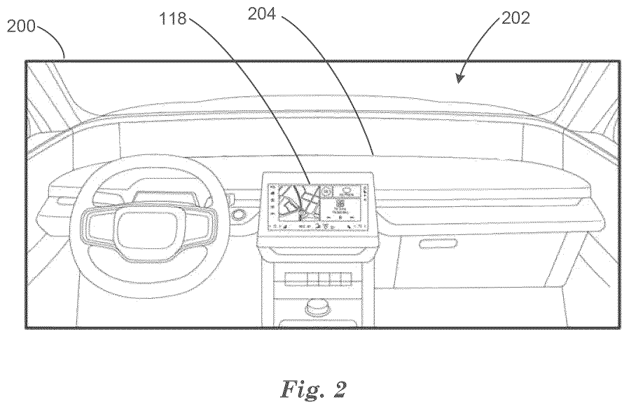

FIG. 2 is a diagram of an image 200 of a portion of a vehicle interior 202 including a dashboard 204. The dashboard 204 can include a display device 118. Display device 118 can be controlled by computing device 115 via display controller 117 to display status data regarding vehicle status such as speed and remaining energy, vehicle environmental controls such as heating and cooling, infotainment controls including audio and video data, navigation data such as maps and directions, and connectivity data such as web pages and phone calls, etc.

Display device 118 can also be equipped with a touch screen to permit a user to enter commands by touching the display device 118. For example, display device can be programmed by computing device 115 to display buttons, dials, or other types of controls. By touching the displayed controls, a user can enter commands that can be received by computing device 115. Commands entered via a touch screen included in a display device 118 can be used by computing device 115 to control vehicle components such as environmental, infotainment, environmental, or connectivity.

Display device 118 is an LCD device. Display device 118 can be used to display a variety of types of data in varying ambient light conditions. The ambient light conditions can range from bright sunlight to dark night, for example. Data can be displayed at brightness levels ranging from dim to bright. As mentioned above, visibility of a feature displayed on display device 118 can be a function of brightness, ambient light, and the size of the feature. Fine detail such as lines that indicate status or controls should be displayed with sufficient brightness given the ambient light to permit a user to see the status or locate the control visually. Techniques described herein for zone display illumination can save power by dimming LED backlight illumination for portions of an LCD device that are displaying dim data while increasing LED backlight illumination in portions of a display device referred to herein as zones that include fine detail to permit users to see the fine detail despite ambient light.

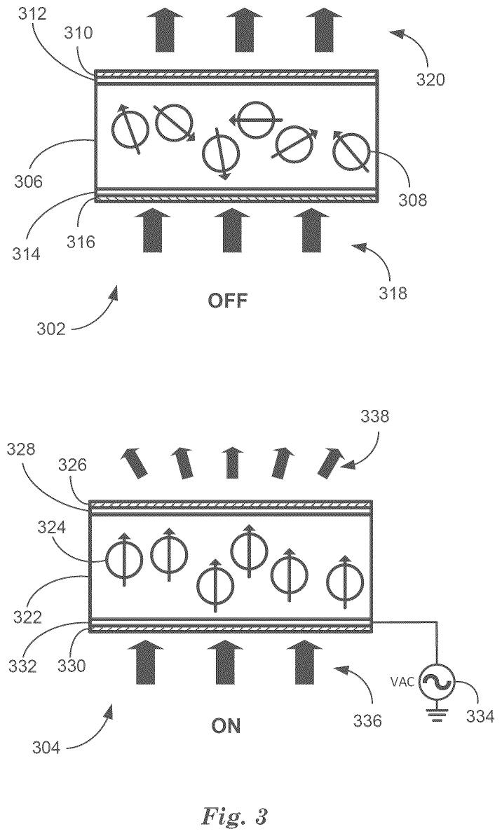

FIG. 3 is a diagram of two cross sectional views of portions of liquid crystal display (LCD) panels 302, 304 that could be included in a display device 118. An LCD panel 302, 304 can be included in a display device 118. LCD panels 302, 304 can receive data from a computing device 115 via a display controller 117 to cause portions of the LCD panel 302, 304 to be opaque or transparent in a pattern that causes the LCD panel 302, 304 to display the received data by transmitting or blocking input light 318, 336. The input light 318, 336 can be supplied by an LED backlight as described below in relation to FIGS. 4-6.

LCD panel 302 is shown as a cross-sectional view of a twisted nematic liquid crystal display in an ON state. LCD panel 304 is shown as a cross-sectional view of a twisted nematic liquid crystal display in an OFF state. A liquid crystal display includes two paired polarizer layers 310, 316 and 326, 330. The paired polarizer layers 310, 316 and 326, 330 are arranged to be at 90-degree polarization angles, which causes the LCD panel 302 to be in the ON state and transmit light, or 0 degrees, which causes the LCD panel 304 to inhibit the transmission of light. The interior space 306, 322 of the LCDs can be filled with liquid crystal molecules 308, 324, which can form a material that rotationally polarizes light such as a twisted nematic liquid crystal molecule. LCD panels 302, 304 do not emit light directly, but transmit varying degrees of input light 318, 336, depending upon voltage 334 applied to thin film transistor (TFT) electrodes 314, 332, generating output light 320, 338 that passes through RGB filter 312. The TFT electrodes 314, 332 can be applied to a glass substrate and can be made of a transparent, conductive material such as indium-tin oxide (ITO).

Assuming an ON state of the LCD panel 302, 90-degree polarization is provided when input light is applied, then in the OFF state, the liquid crystal molecules 308, 324 assume a helical pattern adjacent to the TFT electrodes 314. The helical pattern imparts a 90-degree polarization in light 318 being transmitted by LCD panel 302. The 90-degree polarization imparted to the light causes the input polarizer 316 to match the output polarizer 310, which permits a large percentage of the input light 318 to appear as output light 320. Applying a voltage 334 across the TFT electrodes 332 causes the liquid crystal molecules 324 to align with respective first ends towards one electrode 328 and their other ends towards the other electrode 332, which prevents the liquid crystal molecules from imparting a polarization to the input light 336 which then permits the crossed polarizer layers 326, 330 to block light, making the LCD panel 304 non-transmissive and reducing the light output 338 from the LCD panel 304. Varying voltage 334 can change the light output 320, 338 from bright (no voltage) to dark (maximum voltage) depending upon the voltage.

In addition to varying voltage 334 to determine light output 320, 338, light output 320, 338 can depend upon the light input 318, 336. A technique for supplying light input 318, 336 to an LCD panels 302, 304 is to apply a reflective layer of material beneath the lower polarizer 316, 330 to reflect light incident on the LCD panels 302, 304 from above. This technique has the advantage of utilizing no power or wiring but is dependent upon ambient lighting to make the LCD panels 302, 304 legible, for example, readable or viewable by a person. Backlighting is a technique for applying illumination to an LCD panels 302, 304 from beneath the lower polarizer 316, 330. Techniques for backlighting include edge lighting, which supplies light to a transparent layer of material from the lateral edges of the LCD panels 302, 304. This light can be supplied by LEDs or cold cathode fluorescent lamps, for example. These technologies supply uniform light to backlight the entire LCD panels 302, 304.

Techniques for zone lighting of LCD devices use LED backlighting and RGB filter 312 to enhance visibility of data displayed on an LCD device while permitting control of the intensity of the backlight illumination in zones which group adjacent LEDs. LED backlights are described in relation to FIG. 4, below. Controlling the intensity of the backlight illumination permits power saving by turning down the intensity of dim portions of the data displayed on the LCD device. Because the LCD device operates by blocking light emitted from the backlight, the backlight can be dimmed to save power consumed by the LEDs without changing the appearance of the display. By controlling the LED backlight in zones, zones that correspond to portions of the LCD panel 302, 304 that include data having small details can be controlled to ensure that the small details are visible in varying ambient light conditions. For example, if map data is displayed in ambient light conditions that include bright sunlight, data corresponding to roads in dark portions of the map data can be enhanced by increasing the energy controlling the illumination of LEDs in a zone corresponding to the dark portion of the map data.

FIG. 4 is a diagram of a cross-sectional view of a portion of a display device 118. Display device 118 includes an LCD panel 402 and an LED backlight 404. LCD front panel 402 includes liquid crystal 406, polarizer layers 408, 414, RGB filter 410, and TFT electrodes 412. As described above in relation to FIG. 3, LCD panel 402 modulates light emitted by LED backlight 404 to form a display on the LCD panel 402 based on data that energizes TFT electrodes 412 to block or transmit light emitted from LED backlight 404. TFT electrodes 412 are patterned, generally in a grid pattern that permits addressing the TFT electrodes 412 in an x, y pattern by a computing device 115 to display image data on display device 118.

LED backlight 404 includes white LEDs 418, 420, 422 as described above, referred to herein collectively as LEDs 424. LEDs 424 are attached to a backlight substrate 416 that supplies power controlled by computing device 115 to the LEDs 424. Light emitted by white LEDs 418, 420, 422 illuminate LCD panel 402 and is either blocked or transmitted through liquid crystal molecules 406 to RGB filter 410 which include red 426, green 428, and blue 430 sub-pixels depending upon whether the TFT electrodes 412 are energized by computing device 115. An array of LEDs 424 can be attached to backlight substrate 404 to form display device 118. Hundreds or thousands of LEDs 424 can be attached to backlight substrate 404 to form a backlight for display device 118, the LEDs 424 and can be divided into zones of adjacent LEDs 424.

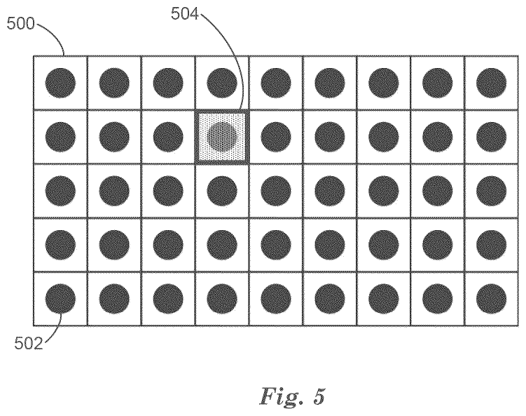

FIG. 5 is a simplified diagram of a top-down view of LED backlight panel 500 included in a display device 118. LED backlight panel 500 includes an array of LEDS 502. Multiple LEDs 502 can be laid out in a grid patten on LED backlight panel 500 to illuminate the LCD front panel 402. LEDs 502 can be divided into LED zones which include one to three LEDs 502 on the LED backlight panel 500. Example LED zone 504 includes one LED 502. An LED zone 504 can include about 12 mm×12 mm area, for example. Smaller LED zones 504 can permit more accurate control of display device 118 brightness. A typical pixel included in the LCD front panel 402, which includes red 426, green 428, and blue 430 sub-pixels, can be about 0.15 mm×0.15 mm, which means that about 80×80 LCD pixels in the LCD panel 402 are included an LCD zone that is illuminated by LED zone 504.

The illumination provided by LED 502 included in LED backlight panel 500 can be adjusted to provide lower-level illumination in areas of the display device 118 that includes dim data. Dim data includes portions of the data displayed on a display device 118 that have lower illumination intensity, such as dark colors like black, dark brown, or dark gray, for example. Dim data portions of data displayed on a display device 118 can also include fine detail such as roads on maps or lines that define a button or control. Reducing the illumination of dim data portions of data displayed on a display device 118 can reduce the contrast of fine detail included in dim data portions of data displayed on a display device 118. Techniques described herein for zone display control can enhance the visibility of data displayed on a display device 118 while maintaining power savings due to reducing illumination of dim data portions of a display device 118 by dividing the LED backlight panel 500 into zones 504 that each include a portion of the LED 502 included in LED backlight panel 500. Zones 504 that have had the illumination intensity decreased due to dim data that include fine detail such as roads or lines can have the illumination intensity increased in the zone 504 to enhance the visibility of the fine detail without increasing the illumination of the entire display device 118.

FIG. 6 is a diagram of an LCD zone 600 included in an LCD panel 402. LCD zone 600 includes a 3×3 array of pixels 602 Each pixel 602 can include a red 604, a green 606, and a blue 608 sub-pixel. The sub-pixel illumination intensities can be encoded an eight-bit values which can range from 0-255. Sub-pixel intensities can be determined by computing device 115 based on image data to be displayed on display device 118. Sub-pixel intensities are based on values of pixels included in portions of image data to be displayed corresponding to the LCD zone 600 Example sub-pixel intensities for LCD zone 600 are illustrated in Table 1.

TABLE 1
Example RGB pixel values for a zone.

| | | |
|---|---|---|
| Pixel 1: R, G, B = 255, 25, 52 | Pixel 2: R, G, B = 80, 80, 212 | Pixel 3: R, G, B = 24, 90, 34 |
| Pixel 4: R, G, B = 56, 156, 33 | Pixel 5: R, G, B = 100, 127, 32 | Pixel 6: R, G, B = 88, 230, 45 |
| Pixel 7: R, G, B = 56, 34, 78 | Pixel 8: R, G, B = 127, 67, 22 | Pixel 2: R, G, B = 156, 88, 90 |

Zone boost values can be determined by computing device 115 based on the data to be displayed on LCD device 118. In this example the LCD zone 600 includes a 3×3 (i.e., three-by-three) array of pixels 602, however, an LCD zone 600 can typically include a greater number of LCD pixels 602 as discussed above in relation to FIG. 5. The number of LCD pixels 602 included in an LCD zone 600 typically depends upon the number of pixels per unit area of displayed data and the minimum size (typically expressed as a number of pixels of width) of the fine detail to be enhanced by this technique. As mentioned above, in examples discussed herein, the minimum size of the fine detail to be enhanced can include a width of one to two pixels.

Once the LCD zones 600 are determined, the first percentage of individual red 604, green 606, and blue 608 sub-pixels within each LCD zone 600 that exceed a sub-pixel threshold can be determined. The sub-pixel threshold indicates the presence of fine detail in the LCD zone 600. Fine detail is indicated by a feature indicated by red 604, green 606, and blue 608 sub-pixels within each zone that contrast with adjacent LCD pixels 602 by a high contrast value. In examples described herein, a high contrast value is indicated by a sub-pixel intensity value of at least 200 in one of the colors included in a LCD pixel 602, where the maximum pixel value is 255.

The intensity value can be empirically determined by a manufacturer or designer based on sampling a large number of images that include fine detail portions of display data under various respective amounts of ambient light, where the amounts of ambient light are those expected to be present in use of the display device 118. A distribution of intensity values included in fine detail sub-pixels can be determined and a sub-pixel threshold can be determined based on the distribution of values. Assuming a normal distribution for fine detail sub-pixel values, setting the sub-pixel threshold to a value equal to two standard deviations below the mean would capture 97.8% of the fine detail sub-pixels in the distribution of sub-pixel values. In this example, a value of 200 would capture 97.8% of the fine detail sub-pixels. The sub-pixel threshold can be stored in memory of computing device 115 and applied to images to be displayed on display device 118 to determine when to boost LED zones 504 as described below. For example, if the sub-pixel threshold is set to 200, pixels 1, 2, and 6 in Table 1 exceed the sub-pixel threshold, then the percentage of sub-pixels that exceed the sub-pixel threshold is calculated as 3/9=33%. In examples of this technique, multiple first percentages can be determined based on multiple percentage thresholds.

The first percentage is next assessed to determine whether it meets one of multiple zone boost thresholds. Boost refers to setting intensity values of the LCD pixels 602 to increased values by multiplying the values of the LCD pixels 602 by a boost value that would increase the values of the pixels in the zone so that the value of the brightest pixel in the zone is equal to a new maximum value as further discussed below. The first zone boost threshold can be selected to capture as many zones as possible while suppressing random noise, for example, 5%. If the first percentage meets the first zone boost threshold, a backlight boost value of 60% of full luminance can be applied to the sub-pixels of the zone to set intensity values of the LEDs 502 included in the LED zone 504 corresponding to the LCD zone 600. If it reaches a second zone boost threshold (e.g., 30%), the LEDs 502 can be boosted to 80% of full luminance. Upon reaching a third zone boost threshold (e.g., 50%), the LEDs 502 in the LED zone 504 can be boosted to 100% of their full luminance.

For example, if the value of the brightest pixel in the zone is 40% of the maximum brightness, and the target value is 80% of the maximum value, the boost value would be 80/40=2. The brightness value of all the pixels included in the zone would be multiplied by a boost value of 2 to boost the brightness of the zone to 80% of the maximum brightness. These percentage thresholds can be adjusted based on empirical data acquired by users evaluating displays in vehicles or simulations under varying ambient light conditions. In some examples greater numbers of zone boost thresholds steps for increasing intensity values of LEDs 502 in the LED zone 504 may be incorporated. The boost values are applied to intensity values included in image data in memory of computing device 115. The image data including the boost values is transmitted to the LED zone 504 included in LED backlight panel 500 of display device 118 by display controller 117.

To enhance luminance uniformity across displays, zones adjacent to the LED zone 504 being adjusted, whether horizontal, vertical, or diagonal, can also be boosted, albeit to a lower luminance level. For instance, if a particular LED zone 504 is boosted to 60% of its full luminance, the adjacent zones can be increased to 30% of their full luminance. Other percentages for adjacent zones can be determined empirically by users evaluating displays as above under varying ambient light conditions.

Techniques described herein can also employ ambient light sensors to enable dynamic adjustments to zone display illumination based on ambient light. An ambient light sensor can be a photodiode or a video camera, for example. Computing device 115 can receive data from the photodiode or video camera and determine an ambient light level in lux. The first example of dynamic zone display illumination is differentiation between daytime and nighttime scenarios. When ambient light falls below a specified threshold, such as 100 lux, the nighttime scenario can be activated. Conversely, the daytime scenario can be activated when ambient light exceeds 100 lux. The primary distinction between these scenarios lies in the light boosting percentages at various levels. For instance, under the nighttime scenario, activation can include boosting the LEDs 502 to only 10%, 18%, and 25% of their full luminance when the percentage of pixels exceeding a value of 200 lux reaches 5%, 30%, and 50%, respectively. In the daytime scenario, activation includes boosting the LEDs 502 as described above. In some examples, more levels of ambient illumination can be combined with additional boost levels.

In other examples, techniques for zone display illumination can analyze expected user interface (UI) changes to data to be displayed based on user interactions. For example, a user can select a new application for a display which will change the overall display brightness. A user can indicate that a display device should switch from displaying user controls for listening to music to a map for vehicle navigation. Computing device 115 can analyze the data to be displayed and perform proactive backlight adjustments to provide smoother UI transitions. Computing device 115 can determine which zones in the to be displayed data can benefit from increasing the illumination intensity of LEDs 502. For example, if a user is about to navigate to a specific menu or application, such as a map screen, the system can determine that increased illumination in particular zones will be warranted and can proactively boost the LED 502 before the map loads. Similarly, if a user is about to access a sub-menu with significantly different backlight requirements, the system can foresee this need and adjust the luminance levels of the LEDs 502 in advance. Anticipating zone display illumination adjustments in a proactive fashion can enhance display output and can provide a more responsive and seamless user experience.

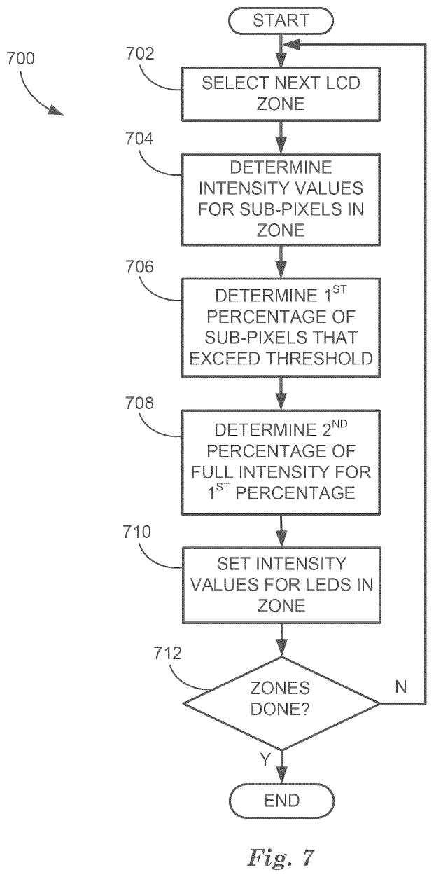

FIG. 7 is a flowchart diagram of a process 700 for controlling LED pixels 502 included in a display device 118. Process 700 can be implemented as software executing on a computing device 115 and hardware including a display device 118 as described herein. Process 700 includes multiple blocks that can be executed in the illustrated order. Process 700 could alternatively or additionally include fewer blocks and can include the blocks executed in different orders.

Process 700 begins in block 702, where computing device 115 selects an LCD zone 600 of included in an LCD front panel 402. The LCD zone 600 can include a 3×3 array of LCD pixels 602 as described in relation to FIG. 6 and Table 1.

At block 704 computing device 115 determines intensities of red 604, green 606, and blue 608 sub-pixels included in LCD pixels 602 included in the selected LCD zone 600. The intensities of red 604, green 606, and blue 608 sub-pixels are based on values included in pixels in image data included in memory of computing device 115 that correspond to LCD zone 600. The pixels in the image data describe the intended brightness of the red 604, green 606, and blue 608 sub-pixels when they are transmitted via display controller 117 to control the illumination emitted by the LCD pixel 602 included in display device 118.

At block 706 computing device 115 compares the intensities for red 604, green 606, and blue 608 sub-pixels included in LCD pixels 602 included in the selected LCD zone 600 to a sub-pixel threshold to determine a first percentage of sub-pixels that exceed the sub-pixel threshold as described above in relation to FIG. 6.

At block 708 computing device 115 compares the first percentage to one or more percentage thresholds to determine a second percentage of full illumination to apply to the sub-pixels of the LEDs 502 included in the selected LCD zone 600 as described above in relation to FIG. 6.

At block 710 computing device 115 converts the second percentage to a value and increases the value to the LEDs 502 of the LED zone 600 by the determined percentage to set the illumination intensities of the selected LED zone 504 corresponding to the LCD zone 600 to enhance the visibility of fine detail in dim areas of the display device 118 as described above in relation to FIG. 6.

At block 712 computing device 115 checks to see if the last LCD zone 600 has been selected. If no, process 700 loops back to block 704 to select the next LCD zone 600. If yes, following block 714 process 700 ends.

Any action taken by a vehicle or user of the vehicle in response to one or more navigation prompts disclosed herein should comply with all rules and regulations specific to the location and operation of the vehicle (e.g., Federal, state, country, city, etc.). More so, any navigation prompts disclosed herein are for illustrative purposes only. Certain navigation prompts may be modified and omitted depending on the context, situation, and applicable rules and regulations. Further, regardless of the navigation prompts, users should use good judgement and common sense when operating the vehicle. That is, all navigation prompts, whether standard or “enhanced,” should be treated as suggestions and only followed when safe to do so and when in compliance with any rules and regulations specific to the location and operation of the vehicle.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and technologies, including, without limitation, and either alone or in combination, Java™, C, C++, Python, Julia, SCALA, Visual Basic, Java Script, Perl, HTML, etc. In general, a processor (i.e., a microprocessor) receives commands, (i.e., from a memory, a computer-readable medium, etc.), and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, (i.e., a candidate to an “exemplary widget” should be read as simply referring to an example of a widget).

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system comprising:
a computer including a processor and a memory storing instructions executable by the processor to:
determine intensity values of emitted light for red, green, and blue (RGB) sub-pixels of an LCD device based on data displayed on the LCD device;
determine a first percentage of RGB sub-pixels that have intensity values that exceed a sub-pixel threshold for a first LCD zone of the LCD device to indicate the presence of fine detail in the first LCD zone wherein the LCD device includes multiple LCD zones and the LCD zones include multiple pixels;
determine a second percentage of a full intensity value of emitted light for the RGB sub-pixels in the first LCD zone of the LCD device to increase the intensity value of the brightest pixel in the first LCD zone to a new maximum value based on the first percentage; and
set intensity values of LEDs in a first LED zone to the second percentage of the full intensity value.

2. The system of claim 1, wherein the instructions include further instructions to set the intensity values of LEDs in second LED zones adjacent to the first LED zone to a third percentage of the second percentage of full intensity value.

3. The system of claim 1, wherein the instructions include further instructions to change the second percentage of the full intensity value to a third percentage of the full intensity value based on ambient light acquired by an ambient light sensor.

4. The system of claim 3, wherein the ambient light sensor includes a photodiode or a video camera.

5. The system of claim 1, wherein the first percentage includes multiple first percentages based on multiple percentage thresholds.

6. The system of claim 5, wherein the second percentage includes multiple second percentages of full luminance based on the multiple first percentages.

7. The system of claim 1, wherein the instructions include further instructions to determine the second percentage of full illumination based on analyzing the data to be displayed on the LCD device.

8. The system of claim 7, wherein analyzing the data to be displayed on the LCD device includes determining zones that benefit from increasing the intensity values of the LEDs.

9. The system of claim 1, wherein the LCD device is included in a vehicle.

10. The system of claim 1, wherein determining the intensity value is based on providing visibility for an image, a menu, a virtual button, a virtual control, and/or a map feature.

11. A method comprising:
determining intensity values of emitted light for red, green, and blue (RGB) sub-pixels of an LCD device based on data displayed on the LCD device;
determining a first percentage of RGB sub-pixels that have intensity values that exceed a sub-pixel threshold for a first LCD zone of the LCD device to indicate the presence of fine detail in the first LCD zone wherein the LCD device includes multiple LCD zones and the LCD zones include multiple pixels;
determining a second percentage of a full intensity value of emitted light for the RGB sub-pixels in the first LCD zone of the LCD device to increase the intensity value of the brightest pixel in the first LCD zone to a new maximum value based on the first percentage; and
setting intensity values of LEDs in a first LED zone to the second percentage of the full intensity value.

12. The method of claim 11, further comprising setting the intensity values of LEDs in second LED zones adjacent to the first LED zone to a third percentage of the second percentage of full intensity value.

13. The method of claim 11, further comprising changing the second percentage of the full intensity value to a third percentage of the full intensity value based on ambient light acquired by an ambient light sensor.

14. The method of claim 13, wherein the ambient light sensor includes a photodiode or a video camera.

15. The method of claim 11, wherein the first percentage includes multiple first percentages based on multiple percentage thresholds.

16. The method of claim 15, wherein the second percentage includes multiple second percentages of full luminance based on the multiple first percentages.

17. The method of claim 11, further comprising determining the second percentage of full illumination based on analyzing the data to be displayed on the LCD device.

18. The method of claim 17, wherein analyzing the data to be displayed on the LCD device includes determining zones that benefit from increasing intensity values of the LEDs.

19. The method of claim 11, wherein the LCD device is included in a vehicle.

20. The method of claim 11, wherein determining the intensity value is based on providing visibility for an image, a menu, a virtual button, a virtual control, and/or a map feature.
